(19) United States
(12) Patent Application Publication
(10) Pub. No.: US 2017/0237738 A1
(43) Pub. Date: Aug. 17, 2017

(54) METHOD AND APPARATUS FOR TRACKING DATA ACCESS ROUTE

(71) Applicant: GoGreat CO., LTD., Seoul (KR)

(72) Inventor: Jae Sung LEE, Gimpo-si (KR)

(21) Appl. No.: 15/431,197

(22) Filed: Feb. 13, 2017

(30) Foreign Application Priority Data
Feb. 15, 2016 (KR) 10-2016-0017329

(51) Int. Cl. H04L 29/06

(52) U.S. Cl. CPC H04L 63/10

(57) ABSTRACT

According to an embodiment of the present disclosure, a method for tracking a data access route comprising duplicating, by a data access route management device, network data according to access to a database server of a user device and filtering, by the data access route management device, the network data to data related to an access record and a performance record to the database server through at least one pass-through server of the user device and storing the filtered data.

### CROSS-REFERENCE TO RELATED APPLICATIONS

This patent application claims priority under 35 U.S.C. §119 to Korean Patent Application No. 10-2016-0047329, filed on Feb. 15, 2016, in the Korean Intellectual Property Office, the disclosure of which is incorporated by reference herein in its entirety.

### TECHNICAL FIELD

The present disclosure relates to a data network, and more specifically, to a method and apparatus for tracking a data access route.

### DISCUSSION OF RELATED ART

As technology advances and information technology (IT) environment improves, data protection is becoming increasingly important. Most of the recent security accidents are revealed as leakage by an authorized user, and thus it is very important to find a path through which data is leaked. However, as the IT environment becomes more complicated, data stored in a database is accessed through various steps, causing it more difficult to find leakage route of the data.

A company's database server stores a large amount of important data, e.g., confidential company information and personal information. To protect such important data, various security software (S/W) applications or programs are disclosed. However, since data is leaked through various pass-through servers, it is difficult to grasp the route through which data is leaked by an authorized user.

Although the Internet protocol (IP), access time, structured query language (SQL), or host name of a user device accessing database are recorded, upon accessing the database using a pass-through server, e.g., a web server, it may be difficult to know who an actual final user is.

### SUMMARY

According to an embodiment of the present disclosure, a method for tracking a data access route comprising duplicating, by a data access route management device, network data according to access to a database server of a user device and filtering, by the data access route management device, the network data to data related to an access record and a performance record to the database server through at least one pass-through server of the user device and storing the filtered data.

The method may further comprise creating, by the data access route management device, a pass-through identifier including at least one virtual identifier corresponding to at least one pass-through server by considering the at least one pass-through server to associate with the user device.

The method may further comprise determining, by the data access route management device, an access pattern and a performance pattern of the user device based on data related to the access record and the performance record to the database server, determining whether the access pattern or the performance pattern is a new pattern, and transmitting an automatic report to an administration device when the access pattern or the performance pattern is the new pattern.

The method may further comprise receiving particular pattern information by the data access route management device, and transmitting the automatic report to the administration device when the access pattern is same as the performance pattern.

The method may further comprise classifying the new pattern to a first new pattern or a second new pattern, wherein the first new pattern is, a new pattern where the at least one pass-through server is used by another user device at least once, but combination of the at least one pass-through server is a new pattern, and the second new pattern is a pattern of a server where the at least one pass-through server constituted in an access route is not passed by another user device.

According to another embodiment of the present disclosure, an apparatus for tracking a data access rotate comprising a data access route management device comprising a processor duplicating network data according to access to a database server of a user server. The data access route management device filters the network data to data related to an access record and a performance record to the database through at least one pass-through server of the user server and stores the filtered data.

The processor may create a pass-through identifier including at least one virtual identifier corresponding to at least one pass-through server by considering the at least one pass-through server to associate with the user device.

The processor may determine an access pattern and a performance pattern of the user device based on data related to the access record and the performance record to the database server, determine whether the access pattern and the performance pattern are new patterns, and transmit an automatic report to an administration device when the access pattern and the performance pattern are new patterns.

The processor may receive a particular pattern and transmit an automatic report to an administration device when the particular pattern is same as the access pattern and the performance pattern.

The processor may classify the new pattern to a first new pattern or a second new pattern, and the first new pattern is a new pattern where the at least one pass-through server is used by another user device at least once, but combination of the at least one pass-through server is a new pattern, and the second new pattern is a pattern of a server where the at least one pass-through server constituted in an access route is not passed by another user device.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view illustrating a method for tracking a data access route according to an embodiment of the present disclosure;

FIG. 2 is a flowchart illustrating a method for duplicating and storing network data of a pass-through server according to an embodiment of the present disclosure;

FIG. 3 is a flowchart illustrating a method for registering and managing an access pattern and an operation pattern to database according to an embodiment of the present disclosure;

FIG. 4 is a view illustrating a method for analyzing a route access pattern according to an embodiment of the present disclosure;

FIG. 5 is a view illustrating a method for determining a new access pattern of an apparatus for managing a data access route and for preventing access of a user device according to an embodiment of the present disclosure; and

FIG. 6 is a view illustrating a method for detecting an unusual access pattern of an apparatus for managing a data access route according to an embodiment of the present disclosure.

### DETAILED DESCRIPTION OF EXEMPLARY EMBODIMENTS

Following detailed description regarding the present disclosure refers to the accompanying drawings, which illustrate specific embodiments in which the present disclosure may be implemented. These embodiments are described in sufficient detail to enable those skilled in the art to implement the present disclosure. It should be understood that various embodiments of the present disclosure are different, but need not be mutually exclusive. For example, the particular shape, structure, and characteristic described herein may be implemented in another embodiment without departing from spirit and scope of the present disclosure in connection with one embodiment. Further, it should be understood that the position or arrangement of the individual components within each disclosed embodiment may be varied without departing from spirit and scope of the present disclosure. Therefore, detailed description as below is not intended to be taken in a limiting meaning, and if properly described, scope of the present disclosure is to be limited only by the accompanying claims, along with the full scope of equivalents to which the claims are entitled. The same reference denotations may be used to refer to the same or similar elements throughout the specification and the drawings.

Hereinafter, exemplary embodiments of the present disclosure will be described in detail with reference to the accompanying drawings.

According to an embodiment of the present disclosure, an access route to a pass-through server and a database server may be figured out, and information about an actual user device that has accessed the database may be obtained by finding and associating the relation data between the pass-through server and the database. According to an embodiment of the present disclosure, a method for analyzing and mapping data by associating access records and performance records to a pass-through server and a database server is disclosed.

According to an embodiment of the present disclosure, upon storing database, access records and performance records for accessing database via a bypass path or a pass-through server, it does not cause degradation in performance of a present operational server.

When such method is used, it is possible to identify a final user who accesses the database through a pass-through server.

Hereinafter, a method and an apparatus for tracking a data access route according to an embodiment of the present disclosure will be described in detail as below.

FIG. 1 is a view illustrating a method for tracking a data access route according to an embodiment of the present disclosure.

As illustrated in FIG. 1, a user device 160 may access a database server 120 through at least one pass-through servers 140.

In order to associate access record to the pass-through server 140 and the database server 120 by the user device 160, it is necessary to store the access record and, performance record for each pass-through server in an extra storage without affecting an existing, server. In order to store access record and performance record to each pass-through server 140 by the user device 160, data on the network may be duplicated in real time. Access record and performance record to each pass-through server 140 by the user device 160 are performed based on a virtual identifier creator process (or a private user ID creator process) for identifying data between a network capture process (real time network capture process) and a pass-through server 140 to classify a final user.

According to an embodiment of the present disclosure, the network capture process for real-time duplication of data on the network may be performed by analyzing each layer data on the network, separately storing only portion storing the access record or the performance record on a queue, and recording the data after a predetermined period of time. Access record and performance record for each pass-through server may be recorded by such method.

According to an embodiment of the present disclosure, a virtual identifier creator process may create a virtual identification for providing a data access route of a user device 160. A sequence number is needed to create a virtual identifier for a user device 160. However, it is difficult to associate data between a pass-through server 140 and a database server 120 only by the sequence number. Thus, tag-based ID may be generated in order of access for the user server 160 to the database server 120. For example, when a user device 160 accesses a database server 120 via a first pass-through server and a second pass-through server, the tag scheme is sequential combination of a virtual ID of the first pass-through server, a virtual ID of the second pass-through server, and a virtual ID of the database server, which may serve a virtual identifier or pass-through identifier of the user device 160. In other words, the virtual identifier of the user device 160 may be combination of a virtual ID of the first pass-through server+ a virtual ID of the second pass-through server+ a virtual ID of the database server. The combination of the virtual IDs indicating access route of the user device 160 to the database server 120 may be represented by pass-through identifier. Information about the access route of the user device 160 to the database server 120 ma be obtained via a pass-through identifier.

When a user device 160 accesses a database server 120 through at least one pass-through server, a duplicating server for duplicating data on the separate network (or access record and performance record) for each pass-through server 140 may be needed. If the pass-through server 140 is not physically separated, data (access record and performance record for each pass-through server) on separate network for each pass-through server may be integrated and managed using a separate hardware device.

For example, the network capture process and the virtual identifier creator process as described above may be performed by a data access route management device 100. The data access route management device 100 may duplicate network data, identification/parsing/storage of necessary data among the network data. An integrated storage included in the data access route management device 100 may store necessary data among the network data. For the sake of convenience of explanation, it may be expressed that one data access route management device 100 performs a network capture process and a virtual identifier creator process, but at least one component of the data access route management device 100 may be included in an individual pass-through server to perform a network capture process and a virtual identifier creator process. Further, the data access route management device 100 may be operated by a processor of the data access route management device 100.

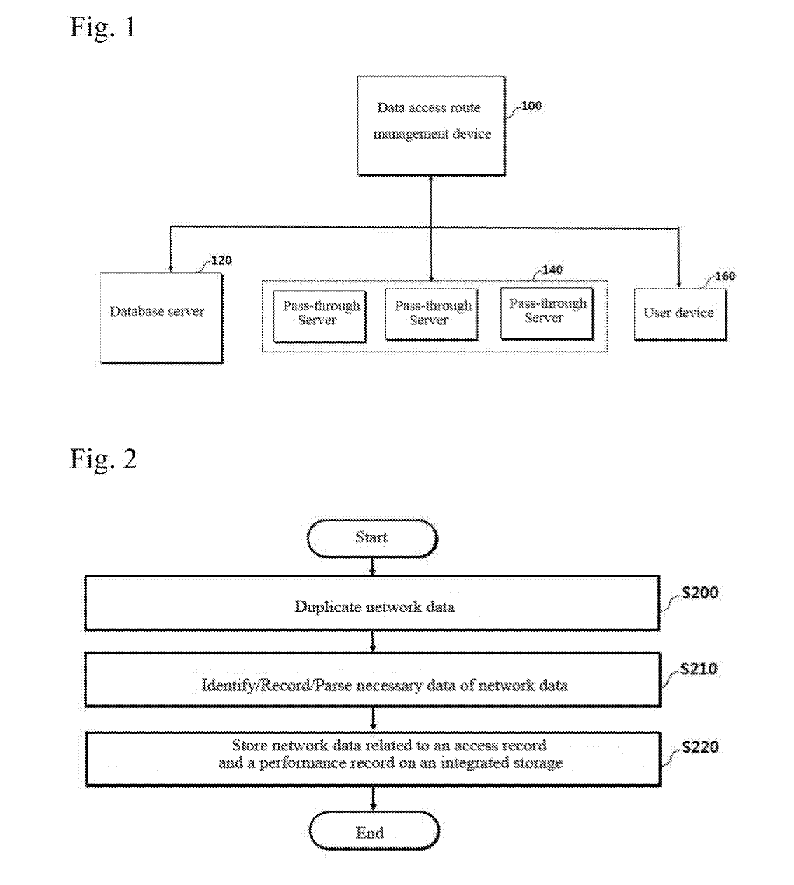

FIG. 2 is a flowchart illustrating a method for duplicating and storing network data of a pass-through server according to an embodiment of the present disclosure.

As illustrated in FIG. 2, a data access route management device duplicates network data in a pass-through server, stores necessary data, and then analyzes a data access route and creates a pass-through identifier indicating the data access route.

Referring to FIG. 2, network data is duplicated (shortly “S200”).

A separate device for duplicating network data of a pass-through server may be provided in a network device. Network data regarding access record and performance record for each pass-through server may be duplicated. A network device may be separately connected to a pass-through server to duplicate network data, or an agent may be directly installed in the pass-through server to duplicate network data.

After the network data is duplicated, necessary data of the network data may be identified, recorded, and parsed (shortly “S210”).

Network data related to access record and performance record of the duplicated network data may be identified, recorded, and parsed. Identifier for identifying each pass-through server is created based on identification of network data related to access record and performance record, and then the data may be transmitted to next pass-through server. In a database server, which is a final destination, each identifier of servers passed through is sequentially recorded to create a pass-through identifier.

Only network data related to access record and performance record may be stored in an integrated storage (shortly “S220”).

Network data related to access record and performance record of the duplicated network data may be stored in an integrated storage, and thus user device data, e.g., access record, performance record, and a pass-through identifier may be stored or managed. The access record of a user device may include the user device's information, e.g., access method, access time, and performance record of a user device may be information about operation performed on a pass-through server by the user device.

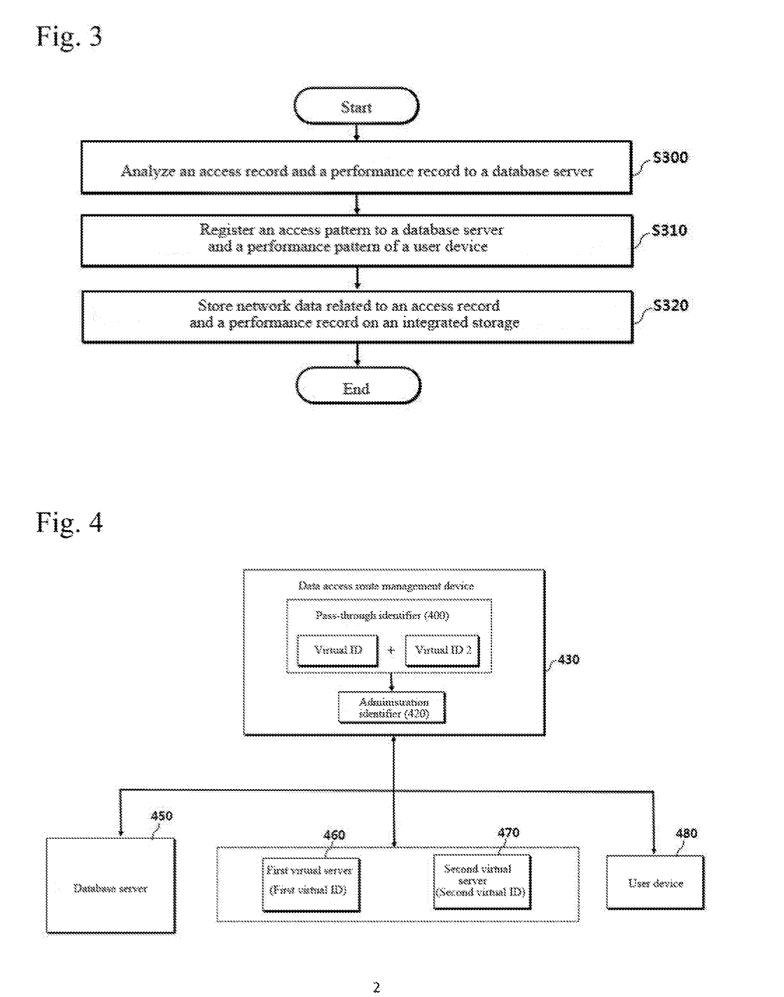

FIG. 3 illustrates a method for registering and managing an access pattern and an operation pattern to database according to an embodiment of the present disclosure.

Referring to FIG. 3, a data access route management device may analyze access record and performance record to a database server by a user device based on a duplicated network data (shortly “S300”).

A data access route management device may analyze an access pattern and a performance pattern by a user device and may register an access pattern to a database server and a performance pattern by a user device (shortly “S310”).

A data access route management device may register an access pattern to a database server and a performance pattern by a user device. When a user device accesses a database server by a new access pattern or a new performance pattern except the registered pattern, the new access pattern or new performance pattern may be separately registered and stored.

For example, an operator easily detects a new access pattern or a new performance pattern based on an integrated dash-board, i.e., a software managing multiple servers, and then discovers unusual symptom. An analytical query software may be registered in an integrated storage, and then a pattern of an anomalous symptom may continuously be updated. Thus, a new access pattern or a new performance pattern may continuously be maintained and managed.

According to an embodiment of the present disclosure, in order to bring data without burdening an existing server, a data access route management device may capture data on a network, duplicate the captured network data to a separated server in real time, and analyze the duplicated data, and records necessary data filtered.

According to an embodiment of the present disclosure, when a user device accesses a database server through a pass-through server rather than direct access, a data access route management device may analyze access record and performance record to manage and store them.

A data access route management server may generate a pass-through identifier by giving a virtual ID according to access order for each server and may manage access record, performance record, and a pass-through identifier of the user device in association with the user device.

Upon at least one pass-through server to be analyzed, a data access route management device may analyze integrated data for at least one pass-through server, analyze patterns, detect a new pattern that is different from the past used pattern to create an automatic report, and provide the report to an administrator. In addition to the automatic pattern registration of access record and performance, if an administrator registers a particular pattern and access and performance in the pattern is detected, an automatic report may be submitted by a data access path management device.

FIG. 4 is a view illustrating a method for analyzing a route access pattern according to an embodiment of the present disclosure.

FIG. 4 illustrates a method for a user device to set and manage a virtual identifier including information on an access route to a database server via a pass-through server.

Referring to FIG. 4, a data access route management device 430 may easily manage a virtual identifier including information about access pattern through pass-through servers 460 and 470 by a user device 480 with a management identifier 420 according to accumulation of information about access pattern.

Initially, a data access route management device 430 generates a combination of tagged virtual IDs (or a pass-through identifier 400) in the order of pass-through via the pass-through server for accessing a database server 450 by a user device 480.

When data on an access route of a user devices 480 to a database server 450 is accumulated through by tag ID generation, a data access route management device 430 may map and manage information about route frequently used by a user device 480 to a separate management identifier.

When a user device 480 accesses a database server 450 via a first pass-through server 460 and a second pass-through server 470, a virtual identifier of the user device 480 may be combination of a virtual ID of the first pass-through server 460+ a virtual ID of the second pass-through server 470+ a virtual ID of the database server 450.

When a certain threshold or more of user devices 480 access a database server 450 through a first pass-through server 460 and a second pass-through 470, a data access route management device 430 may map a virtual identifier which is combination of a virtual II) of the first pass-through server 460+ a virtual ID of the second pass-through server 470+ a virtual ID of the database server 450 to one management identifier.

For example, the data access route management device 430 may map a virtual identifier which is combination of a virtual ID of the first pass-through server 460+ a virtual ID of the second pass-through server 470+ a virtual ID of the database server 450 to one management identifier, e.g., “a” to simply and quickly treat data.

Mapping relation between a pass-through identifier 400 and a management identifier 420 may be established according to access to a database server 450 via the pass-through server by user devices 480. Mapping relation between a pass-through identifier 400 and a management identifier 420 may be newly established by change of a pass-through server frequently used upon access to a database server 450 by a user server 480. For example, when number of access to a database server 450 via a first pass-through server 460 and a second pass-through server 470 is reduced to be threshold number or less, mapping relation between “a” and a virtual identifier which is combination of a virtual ID of the first pass-through server 460+ a virtual ID of the second pass-through server 470+ a virtual ID of the database server 450 is released, “a” as a management identifier 420 may be mapped to another pass-through identifier.

FIG. 5 is a view illustrating a method for determining a new access pattern of an apparatus for managing a data access route and for preventing access of a user device according to an embodiment of the present disclosure

FIG. 5 illustrates a method for determining whether an access pattern of a data access route management device is a new access pattern.

Referring to FIG. 5, when a pass-through identifier of a user device is different from the present managed and stored pass-through identifier, a data access route management device 550 may determine an access pattern of the user device as a new access pattern 550.

When an access pattern of a user device is a new access pattern 550, it may be determined whether the access pattern of the user device is a first new access pattern 510 or a second new access pattern 520.

A data access route management device 550 may classify and manage a new access pattern 500 into two types, e.g., a first new access pattern 510 and a second new access pattern 520.

When all of pass-through servers constituted in an access route are used by other user device at least once, but one combination of pass-through servers generating an access route is new, a data access route management device 550 may determine the access route as a first new access pattern 510. For example, a data access route management device 550 may have information about a first pass-through server passed through by an existing first user device and a second pass-through server passed through by an existing second user device. In this case, when a third user device accesses a database server through the first pass-through server and the second pass-through server, an access pattern of the third user device may be managed as a first new access pattern 510.

When at least one pass-through server constituted in an access route is a server not passed by another user device, a data access route management device 500 may determine the access route as a second new access pattern 520. For example, a data access route management apparatus 500 may have information on a first pass-through server passed by a first user device and a second pass-through server passed by a second user device. In this case, when a third user device accesses a database server via a third pass-through server, an access pattern of the third user device may be managed as a second new access pattern 520.

When a user device has a first new access pattern, a data access route management device 500 may transmit a first warning message to a database server.

A first warning message may be a message informing that after a user device accesses a database server, additional verification of the data accessed by the user device is required.

When a user device has a second new access pattern, a data access route management device 500 may transmit a second warning message to a database server.

A second warning message may be a message requesting to determine the additional access authorization to the user device accessing the database server.

By classifying according to a new access pattern and differentiating the access authorization, a database server may be protected without significantly reducing the speed of user device's access to a database server.

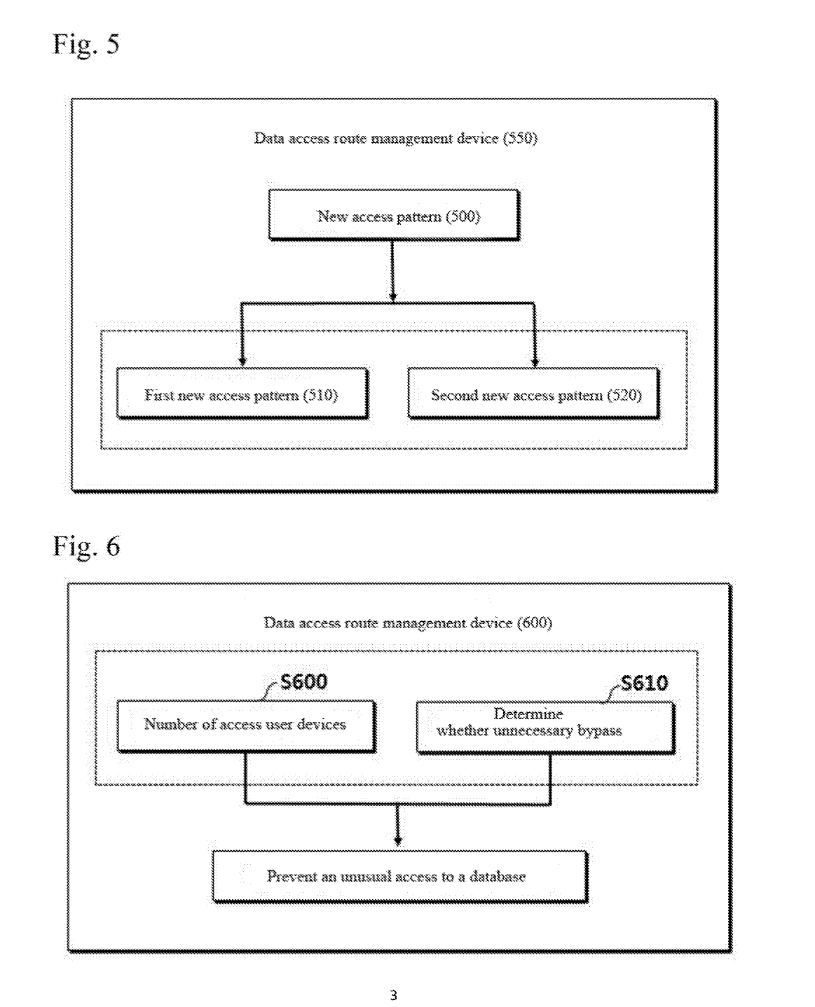

FIG. 6 is a view illustrating a method for detecting an unusual access pattern of an apparatus for managing a data access route according to an embodiment of the present disclosure.

FIG. 6 illustrates a method for detecting an unusual access to a database server by a user server and transmitting information on the unusual access to the database server.

Referring to FIG. 6, a data access route management device 600 may detect an abnormal access to a database through the determination of the number of access user devices.

A data access route management device 600 may determine whether access to a database server of a large-scale user device via a specific pass-through server is performed. When a user device of a threshold number or more access a database server through a specific pass-through server, a data access route management device 600 may transmit a message requesting temporary restriction for access to the database server via the specific pass-through server to the database server.

A data access route management apparatus 600 may prevent an abnormal access to a database server by determining whether an access route of a user device has unnecessarily bypassed based on the access route of the user device (S620).

For example, it is possible to determine whether a user device unnecessarily detours based on information about the route between a first pass-through server firstly passed by the user device and a final pass-through server finally passed before access to a database server by the user device.

A data access route management device 600 may determine an optimal route on the network between an initial pass-through server and a final pass-through server of a user device. The optimal route may be a route that takes the shortest time between the initial pass-through server and the final pass-through server. The data access route management device 600 may determine unnecessary detour of the user apparatus by checking the difference between the optimal route on the network of the user device and an actual route of the user device.

For example, when the difference between the shortest access time and expected access time according to a route of a user apparatus is greater than the threshold value upon access through the optimal route, it may be determined that unnecessary bypassing of the user device occurs.

A method and an apparatus for tracking a data access route according to an embodiment of the present disclosure allow to grasp who a final user is. In addition, a method for recording an access record and a performance record of the data according to an embodiment of the present disclosure may store an access record and a performance record without using an existing server's resource and interruption of the service.

Such methods for tracking a data access route may be implemented in an application or implemented in the form of program instructions that may be executed through various computer components and recorded on a computer-readable recording medium, e.g., program commands, data files, and data structures alone or in combination.

The program instructions recorded on the computer-readable recording medium may be those specially designed and configured for the present disclosure, and may be those known to those skilled in the art of computer software.

Examples of computer-readable media may include a magnetic media such as a hard disk, a floppy disk, and a magnetic tape, an optical recording media such as CD-ROM and DVD, magneto-optical media such as floptical disk, a hardware device that are specially configured to store and execute program instructions such as ROM, RAM, flash memory.

Examples of program instructions include machine language code such as those produced by a compiler, as well as high-level language code that may be executed by a computer using an interpreter or the like. The hardware device may be configured to operate as one or more software modules for performing the process according to the present disclosure, and vice versa.

It will be apparent to those skilled in the art that various modifications and variations may be made in the present disclosure without departing from the spirit or scope of the present disclosure as defined in the appended claims.

What is claimed is:

1. A method for tracking a data access route comprising:
duplicating, by a data access route management device, network data according to access to a database server by a user device; and
filtering, by the data access route management device, the network data to data related to an access record and a performance record to the database server through at least one pass-through server of the user device and storing the filtered data.

2. The method of claim 1, further comprising:
creating, by the data access route management device, a pass-through identifier including at least one virtual identifier corresponding to at least one pass-through server by considering the at least one pass-through server to associate with the user device.

3. The method of claim 2 further comprising:
determining, by the data access route management device, an access pattern and a performance pattern of the user device based on data related to the access record and the performance record to the database server;
determining whether the access pattern or the performance pattern is a new pattern; and
transmitting an automatic report to an administration device when the access pattern or the performance pattern is the new pattern.

4. The method of claim 3 further comprising:
receiving particular pattern information by the data access route management device; and
transmitting the automatic report to the administration device when the access pattern is same as the performance pattern.

5. The method of claim 3 further comprising:
classifying the new pattern to a first new pattern or a second new pattern, wherein the first new pattern is a new pattern where the at least one pass-through server is used by another user device at least once, but combination of the at least one pass-through server is a new pattern, and wherein the second new pattern is a pattern of a server where the at least one pass-through server constituted in an access route is not passed by another user device.

6. An apparatus for tracking a data access route comprising:
a data access route management device comprising a processor duplicating network data according to access to a database server of a user server, wherein the data access route management device filters the network data to data related to an access record and a performance record to the database through at least one pass-through server of the user server and stores the filtered data.

7. The apparatus of claim 6, wherein the processor creates a pass-through identifier including at least one virtual identifier corresponding to at least one pass-through server by considering the at least one pass-through server to associate with the user device.

8. The apparatus of claim 7, wherein the processor determines an access pattern and a performance pattern of the user device based on data related to the access record and the performance record to the database server, determines whether the access pattern and the performance pattern are new patterns, and transmits an automatic report to an administration device when the access pattern and the performance pattern are new patterns.

9. The apparatus of claim 8, wherein the processor receives a particular pattern and transmits an automatic report to an administration device when the particular pattern is same as the access pattern and the performance pattern.

10. The apparatus of claim 8, wherein the processor classifies the new pattern to a first new pattern or a second new pattern, and
wherein the first new pattern is a new pattern where the at least one pass-through server is used by another user device at least once, but combination of the at least one pass-through server is a new pattern, and the second new pattern is a pattern of a server where the at least one pass-through server constituted in an access route is not passed by another user device.
